(19) United States
(12) Patent Application Publication
(10) Pub. No.: US 2016/0170385 A1
(43) Pub. Date: Jun. 16, 2016

(54) METHODS FOR CONFERENCE-ROOM MANAGEMENT AND APPARATUSES USING THE SAME

(71) Applicant: Wistron Corp., New Taipei City (TW)

(72) Inventor: Chun Ching CHEN, New Taipei City (TW)

(21) Appl. No.: 14/662,068

(22) Filed: Mar. 18, 2015

(30) Foreign Application Priority Data
Dec. 10, 2014 (TW) 103142959

(51) Int. Cl. G05B 15/02; H04L 12/28; H04L 12/18

(52) U.S. Cl. CPC G05B 15/02; H04L 12/1818; H04L 12/2816

(57) ABSTRACT

The invention introduces a method for conference-room management, performed by a processing unit, which contains at least the following steps. It is determined whether a condition is satisfied. A conference table of a storage device is updated to release a conference room when the condition is satisfied.

### CROSS REFERENCE TO RELATED APPLICATIONS

This application claims priority of Taiwan Patent Application No. 103142959, filed on Dec. 10, 2014, the entirety of which is incorporated by reference herein.

### BACKGROUND

1. Technical Field

The present invention relates to equipment management, and in particular to methods for conference-room management and apparatuses using the same.

2. Description of the Related Art

A corporation typically provides conference rooms for receiving visitors and holding meetings with employees. However, the reserved conference rooms are often idle because meetings get rescheduled but users can forget to cancel their reservations, resulting in inefficient resource usage. Thus, it is desirable to have methods for conference-room management and apparatuses using the same to improve the usage efficiency of conference rooms.

### BRIEF SUMMARY

An embodiment of the invention introduces a method for conference-room management, performed by a processing unit, which contains at least the following steps. It is determined whether a condition is satisfied. A conference table of a storage device is updated to release a conference room when the condition is satisfied.

An embodiment of the invention introduces an apparatus for conference-room management, which contains at least a storage device and a processing unit. The storage device stores a conference table. The processing unit, coupled to the storage device, determines whether a condition is satisfied; and updates the conference table to release a conference room when the condition is satisfied.

A detailed description is given in the following embodiments with reference to the accompanying drawings.

### BRIEF DESCRIPTION OF THE DRAWINGS

The present invention can be fully understood by reading the subsequent detailed description and examples with references made to the accompanying drawings, wherein:

FIG. 1 illustrates the system architecture for a conference management system according to an embodiment of the invention;

FIG. 2 is the system architecture of a client apparatus according to an embodiment of the invention;

FIG. 3 is the system architecture of a server according to an embodiment of the invention;

FIGS. 4A to 4C are flowcharts illustrating a method for conference-room management according to an embodiment of the invention;

FIG. 5 is a schematic diagram illustrating a display screen according to an embodiment of the invention;

FIG. 6 is a schematic diagram illustrating a reservation update-and-cancel interface according to an embodiment of the invention;

FIG. 7 is a schematic diagram illustrating a reservation insertion interface according to an embodiment of the invention; and

FIG. 8 is a flowchart illustrating a method for conference-room management according to an embodiment of the invention.

### DETAILED DESCRIPTION

The following description is of the best-contemplated mode of carrying out the invention. This description is made for the purpose of illustrating the general principles of the invention and should not be taken in a limiting sense. The scope of the invention is best determined by reference to the appended claims.

The present invention will be described with respect to particular embodiments and with reference to certain drawings, but the invention is not limited thereto and is only limited by the claims. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

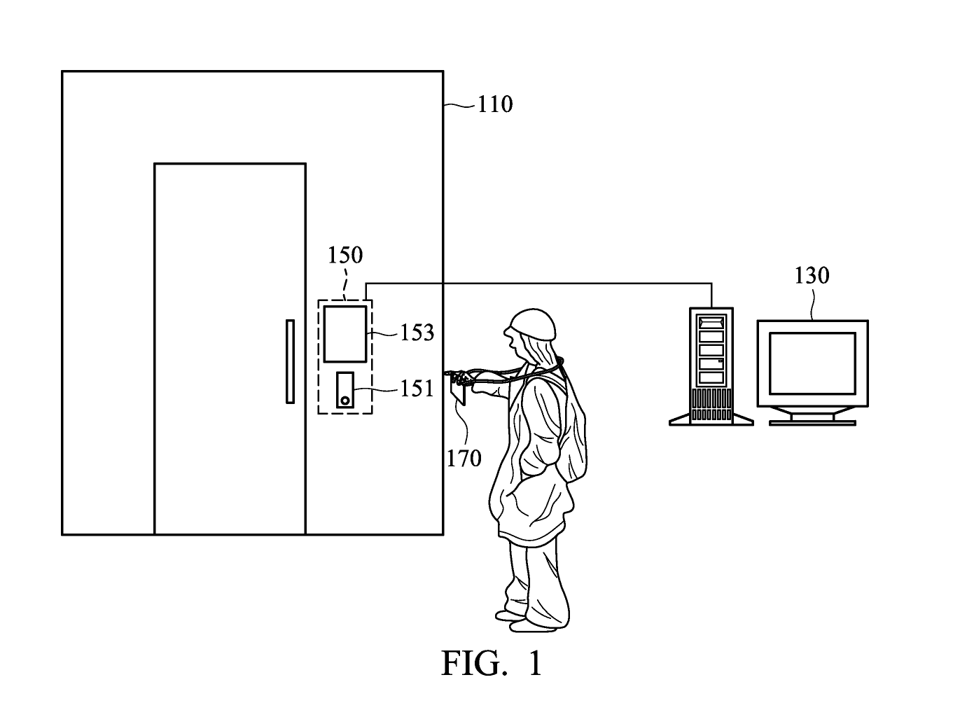

Embodiments of the invention introduce a conference-room management system containing a server and multiple client apparatuses. FIG. 1 illustrates the system architecture for a conference management system according to an embodiment of the invention. A client apparatus 150 may be a tablet computer containing a touch display device 153 and a data reader 151, and the touch display device 153 and the data reader 151 may be disposed on a wall near a door of a conference room 110. The touch display device 153 is equipped with a display panel, such as a TFT-LCD (Thin film transistor liquid-crystal display) panel, or an OLED (Organic Light-Emitting Diode) panel, to display input letters, alphanumeric characters and symbols, and/or reservation information of the conference room 110 for the user to view. The touch display device 153 is further equipped with a touch panel, enabling a user to control an executed application with one or more gestures made on the touch panel. The gestures include, but are not limited to, a single-click, a double-click, a single-finger drag, and a multiple finger drag. The data reader 151 is used to read data from a badge 170 worn by a user when the user enters and leaves the conference room 110. An RFID (Radio-Frequency Identification) tag may be attached to the badge 170 to be identified and contain a code unique to the employee. The data reader 151 may contain a two-way radio transmitter-receiver to send a signal to the RFID tag of the badge 170 and read its response (e.g. the identical code). The client apparatus 150 may employ a wired communications technology (such as LAN, Local Area Network, etc.) or a wireless communications technology (such as WLAN, etc.) to connect to the server 130 for transmitting the identical code read from the RFID tag, sign-in messages and sign-off messages to the server 130. The server 130 may be a desktop computer, a notebook computer or another electronic apparatus with a computation capability.

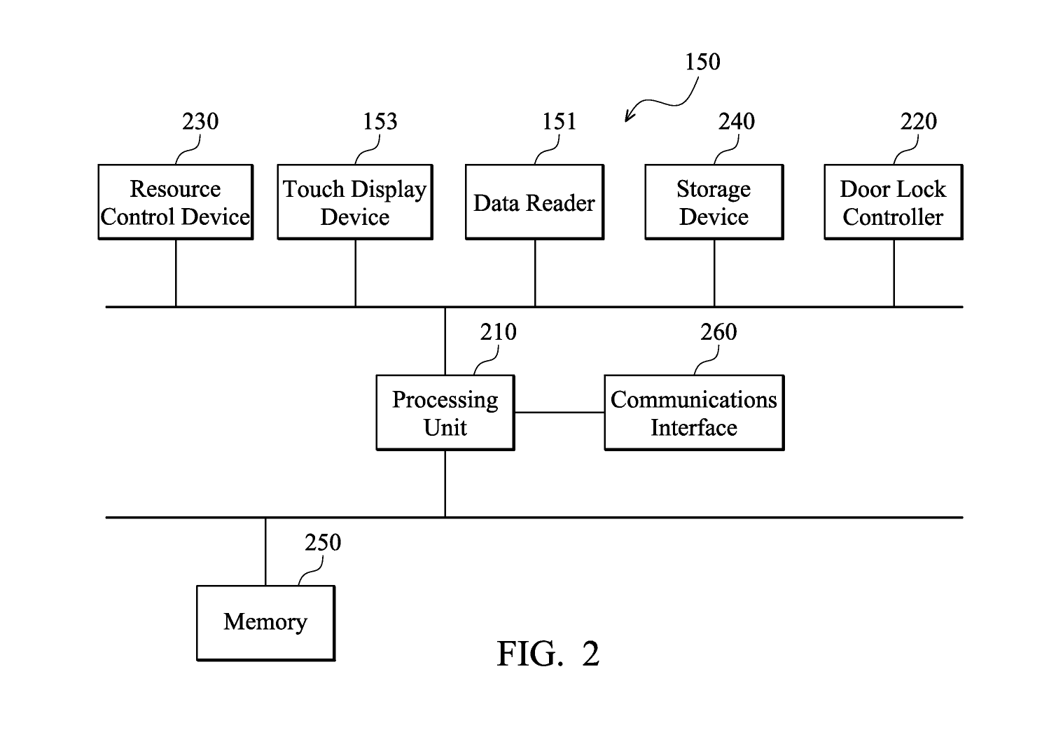

FIG. 2 is the system architecture of a client apparatus according to an embodiment of the invention. The system architecture may be practiced in a tablet computer, containing at least a processing unit 210. The processing unit 210 can be implemented in numerous ways, such as with dedicated hardware, or with general-purpose hardware (e.g., a single processor, multiple processors or graphics processing units capable of parallel computations, etc.) that is programmed using microcode or software instructions to perform the functions recited herein. The system architecture further includes a memory 250 for storing necessary data in execution, such as variables, data tables, etc., and a storage device 240 for storing a wide range of electronic files, such as digital documents, program codes, etc. A communications interface 260 is included in the system architecture and the processing unit 210 can thereby communicate with another electronic apparatus. The communications interface 260 may be a LAN communications module or a WLAN communications module. The system architecture further contains the aforementioned data reader 151 and the touch display device 153. The system architecture may further include a door lock controller 220 to open or close the door of the conference room 110. The system architecture may further contain a resource control device 230 to control a lighting system, an air conditioner, computers and a projector of the conference room 110, etc.

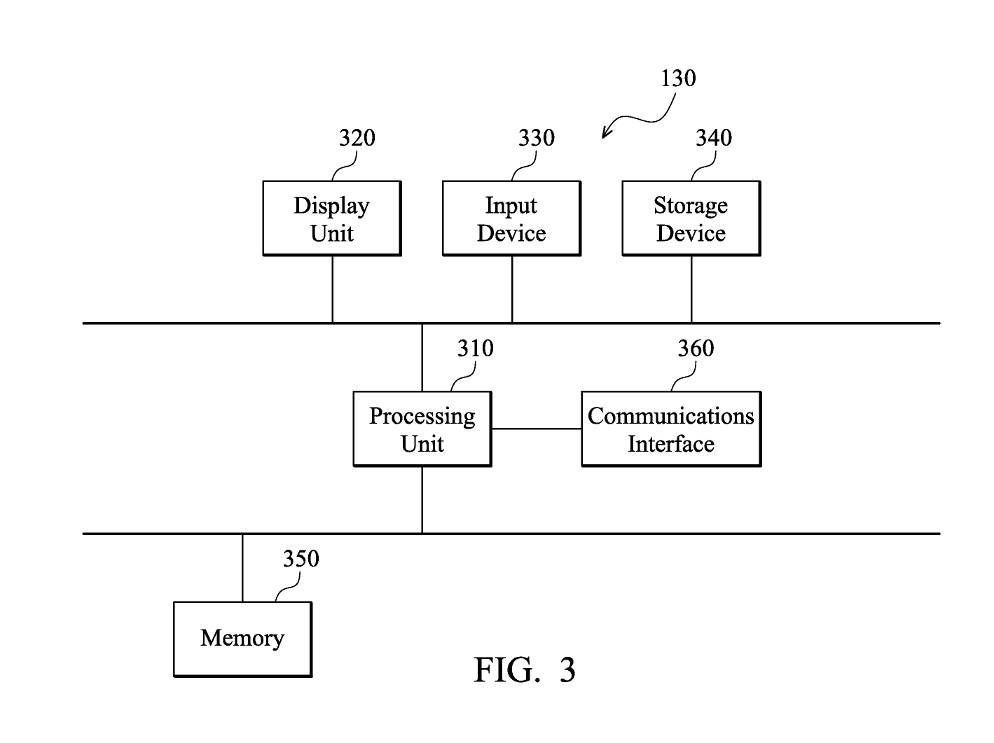

FIG. 3 is the system architecture of a server according to an embodiment of the invention. The system architecture may be practiced in a desktop computers, a notebook computer or another electronic apparatus with a computation capability. A processing unit 310 can be implemented in numerous ways, such as with dedicated hardware, or with general-purpose hardware (e.g., a single processor, multiple processors or graphics processing units capable of parallel computations, etc.) that is programmed using microcode or software instructions to perform the functions recited herein. The system architecture further includes a memory 350 for storing necessary data in execution, such as variables, data tables, etc., and a storage device 340 for storing a wide range of electronic files, such as Web pages, digital documents, video files, audio files, etc. A communications interface 360 is included in the system architecture and the processing unit 310 can thereby communicate with the client apparatus 150 or another electronic apparatus. The communications interface 360 may be a LAN communications module or a WLAN communications module. The system architecture further includes one or more input devices 330 to receive user input, such as a keyboard, a mouse, a touch panel, etc. A user may press hard keys on the keyboard to input characters, control a mouse pointer on a display by operating the mouse, or control an executed application with one or more gestures made on the touch panel. The gestures include, but are not limited to, a single-click, a double-click, a single-finger drag, and a multiple finger drag. A display unit 320 may include a display panel, such as a TFT-LCD (Thin film transistor liquid-crystal display) panel or an OLED (Organic Light-Emitting Diode) panel, to display input letters, alphanumeric characters, symbols, dragged paths, drawings, or screens provided by an application for the user to view.

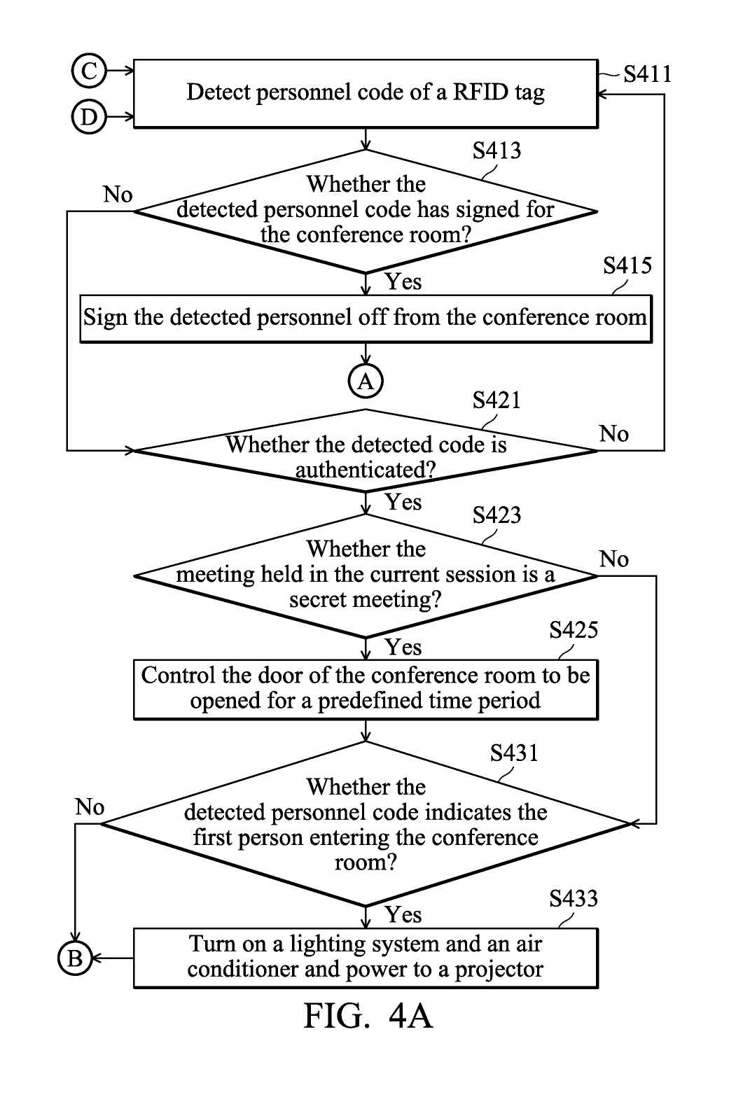

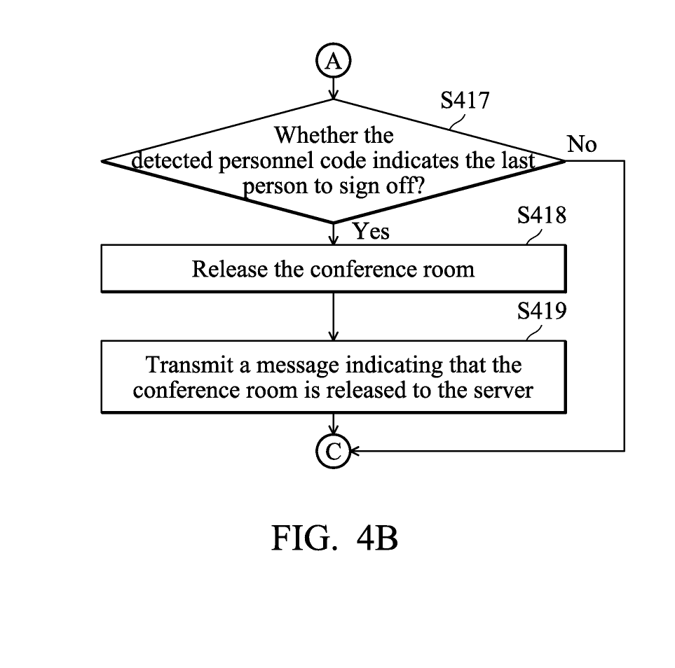

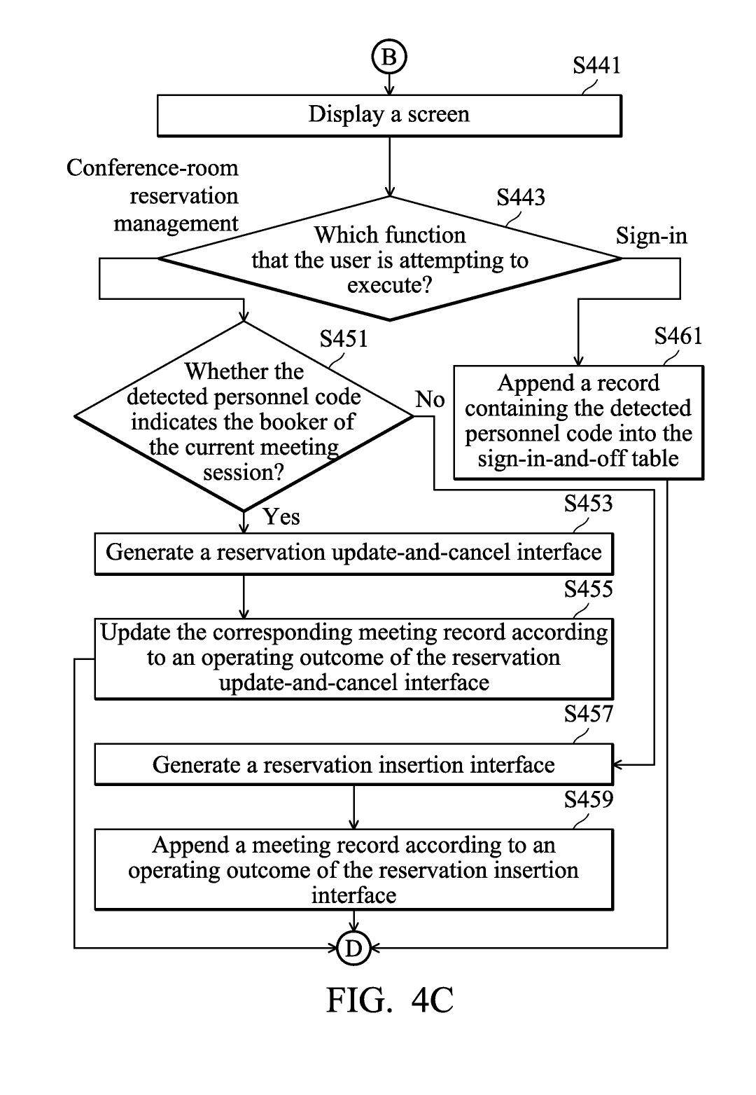

FIGS. 4A to 4C are flowcharts illustrating a method for conference-room management according to an embodiment of the invention. The method is performed by the processing unit 210 of the client apparatus 150, which loads and executes relevant software instructions. The flow periodically executes a loop, which the processing unit 210 determines whether a personnel code of an RFID tag is detected via the data reader 151, and once detecting a personnel code of an RFID tag, performs the following operations (steps S411 to S461). Specifically, after detecting the personnel code of an RFID tag (step S411), it is determined whether the detected personnel code has signed for the conference room 110 (step S413). It should be noted that the personnel code of the RFID tag is unique to an employee or a visitor. The storage device 240 of the client apparatus 150 stores a sign-in-and-off table containing multiple records, and each record stores information regarding the detected personnel code, an employee or visitor identifier, a sign-in time and a sign-off time. In step S413, the processing unit 210 may determine whether a record of the sign-in-and-off table contains the detected personnel code, which is associated with the current session. If so, it means that the detected personnel code has signed for the conference room 110. After determining that the detected personnel code has signed for the conference room 110 (the “Yes” path of step S413), the detected personnel code is signed off from the conference room 110 (step S415). In step S415, the processing unit 210 may write a sign-off time into the sign-in-and-off record containing the detected personnel code to indicate that the detected personnel code is signed off from the conference room 110. An exemplary sign-in-and-off table is shown as follows:

TABLE 1

| | Employee | Sign-in | Sign-off |
|---|---|---|---|
| Personnel code | or visitor ID | time | time |
| E05631Ac56BD0010 | V0001 | 14:03 | 14:55 |
| E05631Ac56BD0020 | E0001 | 14:05 | |

Table 1 contains two sign-in-and-off records. One record stores the personnel code “E05631Ac56BD0010” of the visitor ID “V0001” and information indicating that his or her sign-in and sign-off times are “14:03” and “14:55” respectively. Another record stores the personnel code “E05631Ac56BD0020” of the employee ID “E0001” and information indicating that his or her sign-in time is “14:05” and he or she has not signed off. Then, the processing unit 210 determines whether the detected personnel code indicates the last person to sign off (step S417). After the detected personnel code indicates the last person to sign off (the “Yes” path of step S417), the processing unit 210 releases the conference room 110 (step S418) and transmits a message that indicates that the conference room 110 is released to the server 130 via the communications interface 260 (step S419). The storage device 240 of the client apparatus 150 stores a conference table containing multiple meeting records and each record stores information regarding a meeting number, a reservation time interval, an actual start time, an actual end time, a secret meeting flag and a booker code. An exemplary conference table is shown as follows:

TABLE 2

| Meet- | | | | Secret | |
|---|---|---|---|---|---|
| ing | Reservation | Actual | Actual | Meet- | |
| Num- | Time | Start | End | ing | |
| ber | Interval | Time | Time | Flag | Booker Code |
| 0001 | 14:00~16:00 | 14:03 | 14:58 | No | E05631Ac56BD0020 |
| 0002 | 16:00~18:00 | | | Yes | E05631Ac56BD0030 |

Table 2 contains two meeting records. One record stores the reservation time interval “14:00˜16:00” of the meeting number “0001” and information indicating that the meeting is not a secret meeting. Another record stores the reservation time interval “16:00˜18:00” of the meeting number “0002” and information indicating that the meeting is a secret meeting. When the first sign-in person is detected between the reservation time interval 14:00 and 16:00, the processing unit 210 stores the detected time in the corresponding meeting record as the actual start time. In step S418, for example, when the last person to sign off is detected between the reservation time interval 14:00 and 16:00, the processing unit 210 stores the detected time in the corresponding meeting record as the actual end time. It should be noted that a meeting record storing an actual end time indicates a release of the conference room 110. In step S419, when a message indicating that the conference room 110 is released, a conference-room management application run on the server 130 may update a conference-room management database to store information indicating that the conference room 110 is currently released, thereby enabling a user to reserve the conference room 110.

After determining that the detected personnel code has not signed for the conference room 110 (the “No” path of step S413), the processing unit 210 determines whether the detected code is authenticated (step S421). It should be noted that the storage device 340 of the server 130 stores a personnel table containing multiple records and each record at least stores information regarding an employee or visitor identifier and a personnel code of an RFID tag. In step S421, the processing unit 210 may transmit the detected personnel code to the server 130 to request an authentication via the communications interface 260. After receiving an authentication success message from the server 130 via the communications interface 260, the processing unit 210 determines that the detected personnel code is authenticated. After receiving an authentication fail message from the server 130 via the communications interface 260 or when no message is received after a predefined time has elapsed, the processing unit 210 determines that the detected personnel code is not authenticated.

After the detected personnel code is authenticated (the “Yes” path of step S421), it is determined whether the meeting held in the current session is a secret meeting (step S423). In step S423, the processing unit 210 may read information regarding a secret meeting flag of the corresponding meeting record to determine if the meeting held in the current session is a secret meeting. When the meeting held in the current session is a secret meeting (step “Yes” path of step S423), the processing unit 210 controls the door of the conference room 110 to be opened for a predefined time period, such as 10 seconds, via the door lock controller 220 to prevent the others from entering the conference room 110 (step S425). Regardless of the secrecy of the currently held meeting, the processing unit 210 determines whether the detected personnel code indicates the first person entering the conference room 110 (step S431). In step S431, the processing unit 210 may check the sign-in-and-off table of the storage device 240 to achieve the determination. When no record associated with this reservation time interval is present in the sign-in-and-off table, the processing unit 210 determines that the detected personnel code indicates the first person entering the conference room 110. After determining that the detected personnel code indicates the first person entering the conference room 110 (the “Yes” path of step S431), the processing unit 210 directs the resource control device 230 to turn on the lighting system and the air conditioner and power to the projector (step S433).

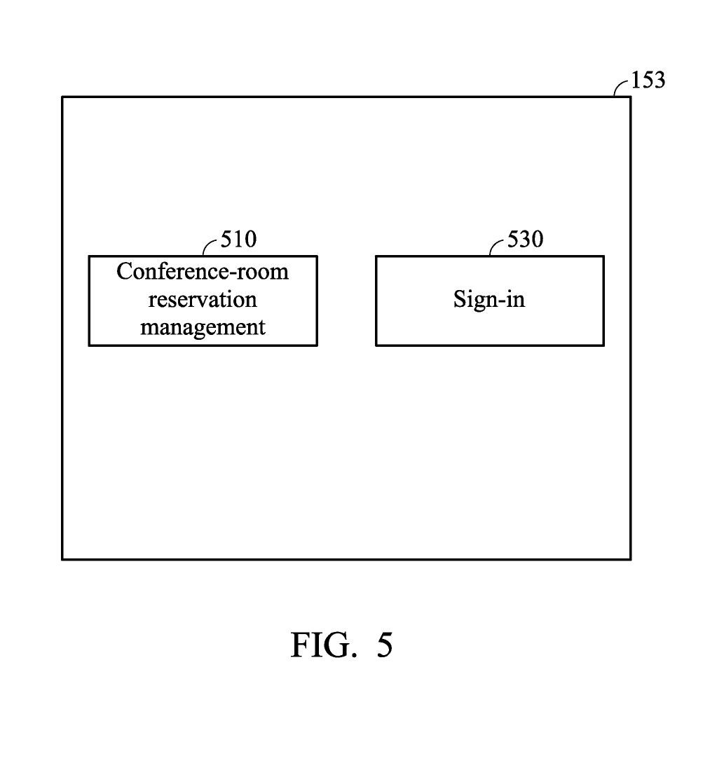

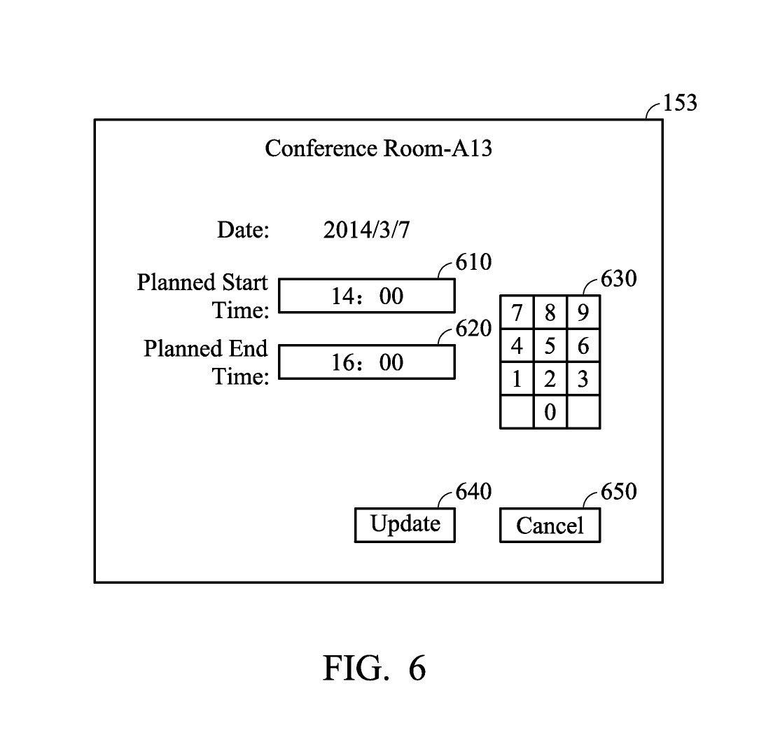

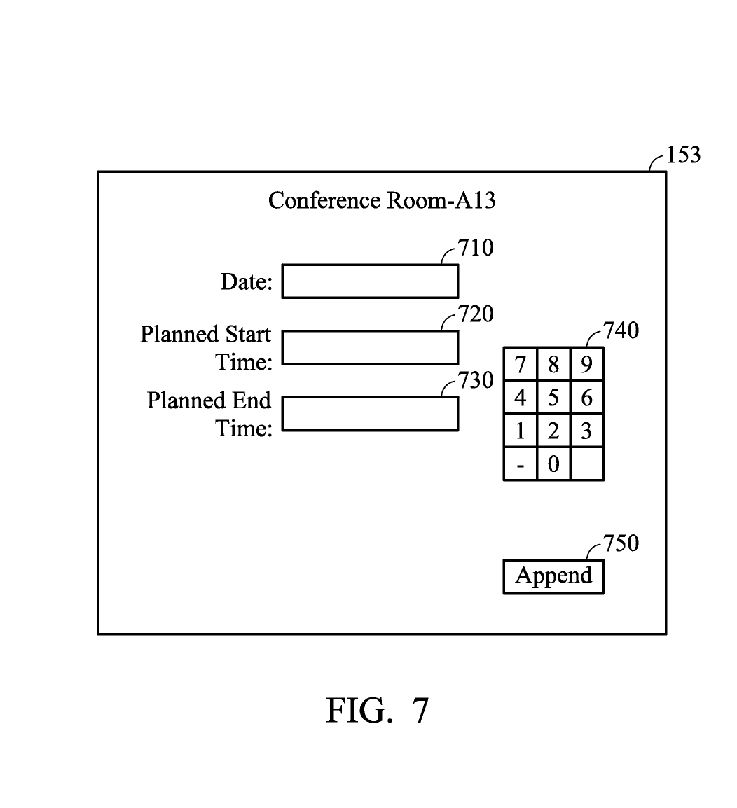

No matter whether the detected personnel code indicates the first person entering the conference room 110, the processing unit 210 directs the touch display device 153 to display a screen to help a user to select a function to be executed (step S441). FIG. 5 is a schematic diagram illustrating a display screen according to an embodiment of the invention. The touch display device 153 displays a conference-room reservation management button 510 and a sign-in button 530. The processing unit 210 subsequently determines which function the user is attempting to execute (step S433). For example, when detecting that the conference-room reservation management button 510 on the touch display device 153 is pressed, the processing unit 210 determines that a conference-room reservation management function is to be executed by the user. When detecting that the sign-in button 530 on the touch display device 153 is pressed, the processing unit 210 determines that a sign-in function is to be executed by the user. After determining that the user attempts to execute the sign-in function (the right branch of step S443), the processing unit 210 appends a record containing the detected personnel code into the sign-in-and-off table (step S461). In step S461, the processing unit 210 may further store the detected time to the record as a sign-in time. After determining that the user is attempting to execute the conference-room reservation management function (the left branch of step S443), the processing unit 210 subsequently determines whether the detected personnel code indicates the booker of the current meeting session (step S451). In step S451, the processing unit 210 may determine whether the detected personnel code conforms to the booker code of the corresponding meeting record of the conference table. If so, the processing unit 210 determines that the detected personnel code indicates the booker of the current meeting session. If so, then the processing unit 210 directs the touch display device 153 to generate a reservation update-and-cancel interface (step S453) and accordingly update the corresponding meeting record according to an operating outcome of the reservation update-and-cancel interface (step S455). FIG. 6 is a schematic diagram illustrating a reservation update-and-cancel interface according to an embodiment of the invention. In step S453, the initial reservation update-and-cancel interface on the touch display device 153 contains information regarding a meeting number, a meeting date, a planned start time and a planned end time. The user may operate a virtual keypad 630 to modify the planned start time of an input field 610 or the planned end time of an input field 620. In step S455, specifically, after the user presses an update button 640, the processing unit 210 reads meeting records of the conference table and inspects whether the meeting date and reservation time interval to be updated conflicts with that of another meeting. If so, then the processing unit 210 directs the touch display device 153 to display a message showing that the modification is disallowed. If not, then the processing unit 210 updates the content of the corresponding meeting record with the input data of the reservation update-and-cancel interface. After the user presses a cancel button 650, the processing unit 210 deletes the corresponding meeting record from the conference table. In addition, in step S455, the processing unit 210 may further transmit the updated or canceled results to the server 130 via the communications interface 260, enabling the conference-room management application run on the server 130 to update the conference-room management database. When detecting that the detected personnel code does not indicate the booker of the current meeting session (the “No” path of step S451), the processing unit 210 directs the touch display device 153 to generate a reservation insertion interface (step S457) and accordingly appends a meeting record according to an operating outcome of the reservation insertion interface (step S459). FIG. 7 is a schematic diagram illustrating a reservation insertion interface according to an embodiment of the invention. In step S457, the user may input a meeting date to a field 710, a planned start time to a field 720 and a planned end time to a field 730 by operating a virtual keypad 740. In step S459, specifically, after the user presses an append button 750, the processing unit 210 reads meeting records of the conference table and inspects whether the meeting to be appended conflicts with an existing meeting. If so, then the processing unit 210 directs the touch display device 153 to display a message showing that the insertion is disallowed. If not, then the processing unit 210 appends a new meeting record into the conference table according to the input data of the reservation insertion interface. In addition, in step S459, the processing unit 210 may further transmit the appended results to the server 130 via the communications interface 260, enabling the conference-room management application run on the server 130 to update the conference-room management database.

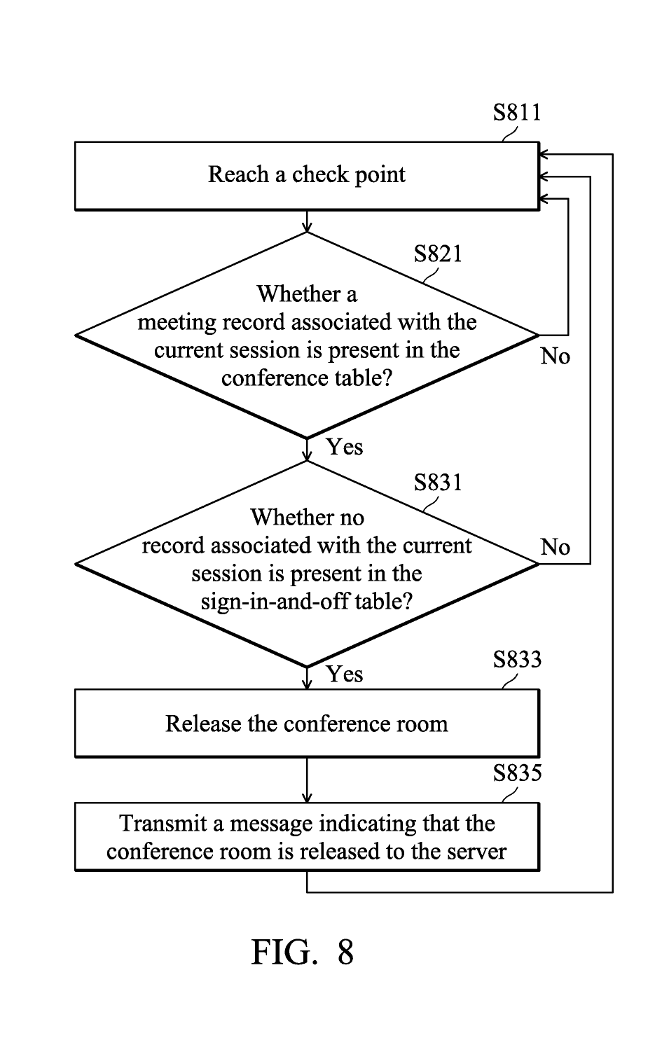

FIG. 8 is a flowchart illustrating a method for conference-room management according to an embodiment of the invention. The method is performed by the processing unit 210 of the client apparatus 150, which loads and executes relevant software instructions. The flow periodically executes a loop, in which each time a check point is reached the processing unit 210 reads the conference table and the sign-in-and-off table to determine whether the conference room 110 has been reserved but no one has signed for, and if so, then the processing unit 210 releases the conference room 110 (steps S811 to S835). Specifically, each time a check point is reached (step S811), it is determined whether a meeting record associated with the current session is present in the conference table (step S821). In step S811, the check point may be set to five minutes past the hour or thirty-five minutes past the hour and an inspection event is received by the processing unit 210 each time the check point is reached. When a meeting record associated with the current session is present in the conference table (the “Yes” path of step S821), the processing unit 210 determines whether no record associated with the current session is present in the sign-in-and-off table (step S831). When no record associated with the current session is present in the sign-in-and-off table (the “Yes” path of step S831), the processing unit 210 releases the conference room 110 (step S833) and transmits a message indicating that the conference room 110 is released to the server 130 via the communications interface (step S835). Details of steps S831 and S835 may refer to the descriptions of steps S418 and S419 respectively.

Although the embodiment has been described as having specific elements in FIGS. 2 and 3, it should be noted that additional elements may be included to achieve better performance without departing from the spirit of the invention. While the process flows described in FIGS. 4A to 4C and 8 each includes a number of operations that appear to occur in a specific order, it should be apparent that these processes can include more or fewer operations, which can be executed in series or in parallel (e.g., using parallel processors or a multi-threading environment).

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for conference-room management, performed by a processing unit, comprising:
determining whether a condition is satisfied; and
updating a conference table of a storage device to release a conference room when the condition is satisfied.

2. The method of claim 1, further comprising:
detecting a personnel code of an RFID (Radio-Frequency Identification) tag via a data reader;
determining whether the personnel code has signed for the conference room;
updating a sign-in-and-off table of the storage device to sign the personnel code off when the personnel code has signed for the conference room;
determining whether the personnel code indicates the last person to sign off; and
the condition is satisfied when the personnel code indicates the last person to sign off.

3. The method of claim 2, wherein the step for determining whether the personnel code has signed for the conference room further comprises:
determining whether a record of the sign-in-and-off table contains the personnel code, which is associated with the current session.

4. The method of claim 1, further comprising:
determining whether a meeting record associated with the current session is present in a conference table after a check point is reached;
determining whether no record associated with the current session is present in a sign-in-and-off table when the meeting record associated with the current session is present in the conference table; and
the condition is satisfied when no record associated with the current session is present in the sign-in-and-off table.

5. The method of claim 1, further comprising:
detecting personnel code of an RFID (Radio-Frequency Identification) tag via a data reader;
transmitting the personnel code to a server for authentication via a communications interface; and
determining that the personnel code is authenticated when an authentication success message is received via the communications interface.

6. The method of claim 5, further comprising:
determining whether a meeting held in the current session is a secret meeting according to a meeting record of the conference table when the personnel code is authenticated; and
controlling a door of the conference room to be opened for a predefined time period via a door lock controller when the meeting held in the current session is a secret meeting.

7. The method of claim 5, further comprising:
directing a touch display device to display a screen when the personnel code is authenticated; and
appending a record including the personnel code into a sign-in-and-off table of the storage device when detecting that a sign-in button on the touch display device is pressed.

8. The method of claim 5, further comprising:
directing a touch display device to display a screen when the personnel code is authenticated;
determining whether the personnel code indicates a booker of the current meeting session when detecting that a conference-room reservation management button on the touch display device is pressed; and
directing the touch display device to generate a reservation update-and-cancel interface and updating the conference table of the storage device according to an operation on the reservation update-and-cancel interface when the personnel code indicates the booker of the current meeting session.

9. The method of claim 8, further comprising:
directing the touch display device to generate a reservation insertion interface and updating the conference table of the storage device according to an operation on the reservation insertion interface when the personnel code does not indicate the booker of the current meeting session.

10. The method of claim 1, further comprising:
detecting a personnel code of an RFID (Radio-Frequency Identification) tag via a data reader;
determining whether the personnel code indicates the first person entering the conference room; and
directing a resource control device to turn on a lighting system and an air conditioner and power to a projector.

11. An apparatus for conference-room management, comprising:
a storage device, storing a conference table; and
a processing unit, coupled to the storage device, determining whether a condition is satisfied; and updating the conference table to release a conference room when the condition is satisfied.

12. The apparatus of claim 11, further comprising:
a data reader,
wherein the processing unit detects a personnel code of an RFID (Radio-Frequency Identification) tag via the data reader; determines whether the personnel code has signed for the conference room; updates a sign-in-and-off table of the storage device to sign the personnel code off when the personnel code has signed for the conference room; determines whether the personnel code indicates the last person to sign off; and determines that the condition is satisfied when the personnel code indicates the last person to sign off.

13. The apparatus of claim 12, wherein the processing unit determines whether the personnel code has signed for the conference room by determining whether a record of the sign-in-and-off table contains the personnel code, which is associated with the current session.

14. The apparatus of claim 11, wherein the processing unit determines whether a meeting record associated with the current session is present in a conference table after a check point is reached; determines whether no record associated with the current session is present in a sign-in-and-off table when the meeting record associated with the current session is present in the conference table; and determines that the condition is satisfied when no record associated with the current session is present in the sign-in-and-off table.

15. The apparatus of claim 11, further comprising:
a data reader; and
a communications interface,
wherein the processing unit detects a personnel code of an RFID (Radio-Frequency Identification) tag via the data reader; transmits the personnel code to a server for authentication via the communications interface; and determines that the personnel code is authenticated when an authentication success message is received via the communications interface.

16. The apparatus of claim 15, further comprising:
a door lock controller,
wherein the data reader is installed near a door of the conference room, and the processing unit determines whether a meeting held in the current session is a secret meeting according to a meeting record of the conference table when the personnel code is authenticated; and controls the door of the conference room to be opened for a predefined time period via the door lock controller when the meeting held in the current session is a secret meeting.

17. The apparatus of claim 15, further comprising:
a touch display device,
wherein the processing unit directs the touch display device to display a screen when the personnel code is authenticated; and appends a record including the personnel code into a sign-in-and-off table of the storage device when detecting that a sign-in button on the touch display device is pressed.

18. The apparatus of claim 15, further comprising:
a touch display device,
wherein the processing unit directs the touch display device to display a screen when the personnel code is authenticated; determines whether the personnel code indicates a booker of the current meeting session when detecting that a conference-room reservation management button on the touch display device is pressed; and directs the touch display device to generate a reservation update-and-cancel interface and updates the conference table of the storage device according to an operation on the reservation update-and-cancel interface when the personnel code indicates the booker of the current meeting session.

19. The apparatus of claim 18, wherein the processing unit directs the touch display device to generate a reservation insertion interface and updates the conference table of the storage device according to an operation on the reservation insertion interface when the personnel code does not indicate the booker of the current meeting session.

20. The apparatus of claim 11, further comprising:
a data reader; and
a resource control device,
wherein the processing unit detects personnel code of an RFID (Radio-Frequency Identification) tag via the data reader; determines whether the personnel code indicates the first person entering the conference room; and directs the resource control device to turn on a lighting system and an air conditioner and power to a projector.
